(19) United States
(12) Patent Application Publication
(10) Pub. No.: US 2020/0296497 A1
(43) Pub. Date: Sep. 17, 2020

(54) MICROPHONE ASSEMBLY, SYSTEM, AND METHODS

(71) Applicant: Ernest Eugene Morris, Lakewood, CO (US)

(72) Inventors: Ernest Eugene Morris, Lakewood, CO (US); Philip Meiklejohn, Lakewood, CO (US)

(73) Assignee: Ernest Eugene Morris, Lakewood, CO (US)

(21) Appl. No.: 16/761,198

(22) PCT Filed: Oct. 31, 2018
(86) PCT No.: PCT/US2018/058436

§ 371 Date: May 1, 2020

Related U.S. Application Data
(60) Provisional application No. 62/581,289, filed on Nov. 3, 2017.

(51) Int. Cl. H04R 1/04

(52) U.S. Cl. CPC H04R 1/04; H04R 2430/01

(57) ABSTRACT

The disclosure relates to a microphone assembly, system, and methods. The device, system, and methods may be utilized for instruments, including stringed instruments.

### CROSS-REFERENCE TO RELATED APPLICATION

This application claims the benefit of U.S. provisional application No. 62/581,289, which was filed Nov. 3, 2017 and is incorporated herein by reference as if fully set forth.

### FIELD OF THE INVENTION

The disclosure relates to a microphone assembly, system, and methods. The device, system, and methods may be utilized for instruments, including stringed instruments.

### BACKGROUND

Currently, the best way to record sound from an acoustic instrument is from an actual acoustic hybrid. This requires the instrument to be made with a microphone system already installed in the instrument or for an instrument to be modified to install such a device. This requires permanent modification to the instrument which is frequently unacceptable. Other microphone assemblies clip onto the instrument and record sound from the front of the instrument, this results in a “tinny” sound which is highly noticeable to most musicians.

### SUMMARY

In an aspect, the invention relates to a microphone assembly. The microphone assembly comprises an outer shell having an opening and a rim around the opening, a microphone fixed within the outer shell, and a flexible membrane on the rim of the outer shell.

In an aspect, the invention relates to a system. The system comprises at least one microphone assembly, an instrument, and an output device. One of the at least one microphone assembly is attached to a wall of the instrument. One of the at least one microphone assembly comprises an outer shell having an opening and a rim around the opening, a microphone fixed within the outer shell, and a flexible membrane on the rim of the outer shell.

In an aspect, the invention relates to a method of obtaining an audio output from an instrument. The method comprises coupling the instrument with a microphone assembly. The microphone assembly comprises an outer shell having an opening and a rim around the opening, a microphone fixed within the outer shell, and a flexible membrane on the rim of the outer shell. The method may comprise coupling the microphone assembly to one or more further devices.

### BRIEF DESCRIPTION OF THE DRAWINGS

The following detailed description of embodiments of the present invention will be better understood when read in conjunction with the appended drawings. For the purpose of illustrating the invention, there are shown in the drawings embodiments which are presently preferred. It is understood, however, that the invention is not limited to the precise arrangements and instrumentalities shown. In the drawings:

FIG. 1A illustrates a top view of a microphone assembly.

FIG. 1B illustrates an isometric view of a microphone assembly.

FIG. 1C illustrates a front view of the microphone assembly of FIG. 1A.

FIG. 1D illustrates a rear view of the microphone assembly of FIG. 1A.

FIG. 1E illustrates a left view of the microphone assembly of FIG. 1A.

FIG. 1F illustrates a right view of the microphone assembly of FIG. 1A.

FIG. 1G illustrates a bottom view of the microphone assembly of FIG. 1A.

FIG. 1H illustrates section A-A shown on FIG. 1G.

FIG. 1I illustrates an exploded side view of the microphone assembly of FIG. 1A.

FIG. 1J illustrates and exploded offset bottom view of the microphone assembly of FIG. 1A.

FIG. 2A illustrates a top view of a microphone assembly.

FIG. 2B illustrates an isometric view of the microphone assembly of FIG. 2A.

FIG. 2C illustrates a front view of the microphone assembly of FIG. 2A.

FIG. 2D illustrates a rear view of the microphone assembly of FIG. 2A.

FIG. 2E illustrates a left view of the microphone assembly of FIG. 2A.

FIG. 2F illustrates a right view of the microphone assembly of FIG. 2A.

FIG. 2G illustrates a bottom view of the microphone assembly of FIG. 2A.

FIG. 2H illustrates section A-A shown on FIG. 2G.

FIG. 3A illustrates a top view of the microphone assembly of FIG. 2A.

FIG. 3B illustrates an isometric view of a microphone assembly.

FIG. 3C illustrates a front view of the microphone assembly of FIG. 3A.

FIG. 3D illustrates a rear view of the microphone assembly of FIG. 3A.

FIG. 3E illustrates a left view of the microphone assembly of FIG. 3A.

FIG. 3F illustrates a right view of the microphone assembly of FIG. 3A.

FIG. 3G illustrates a bottom view of the microphone assembly of FIG. 3A.

FIG. 3H illustrates section A-A shown on FIG. 3G.

FIG. 3I illustrates an exploded side view of the microphone assembly of FIG. 3A.

FIG. 3J illustrates and exploded offset bottom view of the microphone assembly of FIG. 3A.

FIG. 4A illustrates a top view of a microphone assembly.

FIG. 4B illustrates an isometric view of the microphone assembly of FIG. 4A.

FIG. 4C illustrates a front view of the microphone assembly of FIG. 4A.

FIG. 4D illustrates a rear view of the microphone assembly of FIG. 4A.

FIG. 4E illustrates a left view of the microphone assembly of FIG. 4A.

FIG. 4F illustrates a right view of the microphone assembly of FIG. 4A.

FIG. 4G illustrates a bottom view of the microphone assembly of FIG. 4A.

FIG. 4H illustrates section A-A shown on FIG. 4G.

FIG. 5A illustrates a top view of a microphone assembly.

FIG. 5B illustrates a side view of the microphone assembly of FIG. 5A.

FIG. 5C illustrates another side view of the microphone assembly of FIG. 5A.

FIG. 5D illustrates a bottom view of the microphone assembly of FIG. 5A.

FIG. 5E illustrates a perspective view of the microphone assembly of FIG. 5A.

FIG. 5F illustrates another perspective view of the microphone assembly of FIG. 5A.

FIGS. 6A and 6B illustrate systems with a microphone assembly attached to a wall of an instrument.

FIGS. 7A and 7B illustrate locations that a microphone assembly may make contact with a violin.

FIGS. 8A and 8B illustrate locations that a microphone assembly may make contact with a guitar.

FIG. 9 illustrates an embodiment of a microphone assembly.

FIG. 10 illustrates an exploded view of the embodiment of FIG. 9.

FIG. 11 illustrates various views of the embodiment of FIG. 9.

FIG. 12 illustrates the embodiment of FIG. 9 with a foam ring retention clip.

FIG. 13 illustrates the embodiment of FIG. 9 where retention clip is repositioned.

FIG. 14 illustrates the embodiment of FIG. 9 where retention clip is repositioned.

### DETAILED DESCRIPTION

Certain terminology is used in the following description for convenience only and is not limiting. The words “right,” “left,” “top,” and “bottom” designate directions in the drawings to which reference is made. The words “a” and “one,” as used in the claims and in the corresponding portions of the specification, are defined as including one or more of the referenced item unless specifically stated otherwise. The phrase “at least one” followed by a list of two or more items, such as “A, B, or C,” means any individual one of A, B or C as well as any combination thereof.

An embodiment includes a microphone assembly. The microphone assembly comprises an enclosed microphone, and may be provided in a system. The microphone may be of any type. The microphone may include a sensitive transducer element, often called an element or capsule. Sound is first converted to mechanical motion by means of a diaphragm, the motion of which is then converted to an electrical signal. A shell of the microphone assembly may provide the microphone with a housing, and connections to bring the signal from the microphone to other equipment, and often an electronic circuit to adapt the output of the capsule to the equipment being driven. The equipment being driven may by an amplifier, a mobile device, a cell phone, or a speaker. The microphone may be a wireless microphone containing a radio transmitter. The microphone may be a PCB microphone unit. The microphone may be unidirectional or omnidirectional. The microphone may be a diaphragm microphone. The connections may be a Bluetooth or an audio port. The other equipment may be an amplifier with control inputs.

A system may include an instrument to which the microphone assembly is attached, and optionally one or more of other microphone(s) or accessory device(s) (e.g., at least one of soundboard(s), speaker(s), or recording device(s)) to which the microphone assembly is communicatively coupled by direct or wireless connections. The instrument may be, but is not limited to, a violin, a viola, a cello, a bass violin, a mandolin, a guitar, or a ukulele. The instrument may be a wooden stringed instrument. The instrument may be a hollow bodied instrument. The instrument may be a hollow-bodied, wooden, stringed instrument. The instrument may be constructed of other materials and/or be hollow or solid bodied. A microphone assembly may be attached to an instrument by placing constant pressure on the top of the assembly to create contact between the bottom of the assembly and the wall of the instrument. In an embodiment, this constant pressure is created through use of an elastic band around the instrument. A microphone assembly may be attached to an instrument by vacuum. A microphone assembly may be attached using other configurations as a skilled artisan would deem appropriate. The microphone assembly may be attached to an instrument permanently or temporarily.

The microphone assembly may provide a more natural sound than existing microphones. The microphone assembly may obtain sound waves from the body of the instrument. The body may be wood. The microphone assembly may achieve a much more natural sound than prior microphones and systems. The sound may be warmer, richer, and cleaner the sound achieved with prior microphones. The microphone assembly may comprise buttons on the device to adjust the volume, mute the device, and other inputs. The microphone assembly may comprise an enclosure around a microphone along with a flexible material on the surface that would contact an instrument. The flexible material may isolate the microphone from outside interference as well as focus the microphone on the sound waves emanating from the instrument body itself. The instrument body may be wood. The enclosure, which may be referred to as a shell, may be attached to the instrument via a strap mechanism which holds the enclosure against the wood. The microphone assembly may comprise any attachment mechanisms suitable to hold the assembly in contact with the instrument. For example, a vacuum attachment for a microphone assembly may allow it to be attached with vacuum generated. The vacuum may be generated by displacing air via a crushable seal having a vacuum cavity, turning a dial, lever, or other mechanical mechanism on the microphone assembly. As another example, an adhesive may be present as an attachment on at least one of the microphone assembly or the instrument, and the microphone assembly may be attached to the instrument through the adhesive. The adhesive may be reversible.

A purpose of the present microphone assembly, system, and method is to greatly reduce excessive high frequency noises that are picked up from existing devices.

The microphone assembly may be much easier to install than prior microphones and may not require modification of the instrument itself. This microphone assembly may also include a wireless transmitter device to enable it to communicate with a personal computer, cell phone, or other recording device. A system comprising a microphone assembly may include a personal computer, cell phone, or other recording device communicatively coupled with the a microphone assembly. The coupling may be direct or wireless. The wireless coupling may be via a wireless transmitter. The wireless transmitter may be one of the many existing wireless systems on the market. A non-limiting example of a wireless connection is “Bluetooth®.” The microphone assembly enclosure can be made from a variety of materials like wood, plastics and metals. Between the microphone assembly and the instrument there may be a flexible membrane that conforms to the instrument shape, which can vary widely with some instruments. The flexible membrane may be part of the microphone assembly. The flexible membrane may be of any soft conformable material. It may be foam. The foam may be in the shape of a foam ring adapted to interpose between the rim of the microphone assembly and the instrument. The flexible membrane may also serve as a vacuum seal for a vacuum attachment method by mechanically actuating and drawing a vacuum between the two sides of the membrane, which act as seals against the body of the instrument. The flexible membrane may be attached to the microphone assembly shell by an outer that ring clips onto the shell. The flexible membrane in this embodiment may create a soundproof layer around the microphone that further isolates the microphone from outside noise.

The shape of the microphone assembly may be primarily round or hemispherical, but the shape may be adapted in size and shape to fit certain instruments or meet other requirements. The shape may be adapted for aesthetic reasons. While the body of the microphone assembly may be plastic, wood, or metal, it may also be covered in another material for aesthetic and ergonomic purposes. An outer covering on the microphone assembly may be provided, and may be at least one of durable or washable as well.

A system may be provided with multiple microphone assemblies. In such a system, the microphone assemblies may also be individually numbered. The numbering may allow for identification of individual microphone assemblies easily in situations where more than one is used at a time.

A system and microphone assemblies may integrate with existing sound systems in a simple way that is very similar to traditional microphones. The system may incorporate the use of a noise cancelling system in addition to the noise insulating properties of the flexible membrane, and the materials used on the device.

A microphone assembly may include various accessories including the above-described vacuum attachment accessory. Another accessory that may be in an embodiment is a wireless control panel which would give a central control over at least one of other microphone assemblies or traditional microphones allowing control over individual volume and timing control. Typically “Bluetooth®” can struggle to sync multiple signals. The control panel may allow for automatic and manual tuning of the associated devices' sound and timing. The system may also include an individual memory system for recording audio directly onto a microphone assembly itself. In which case the microphone assembly may also include buttons or a small touch panel to control these options. A microphone assembly may be powered by any suitable source of power. The source of power may be a replaceable battery, rechargeable battery, or an external power cord.

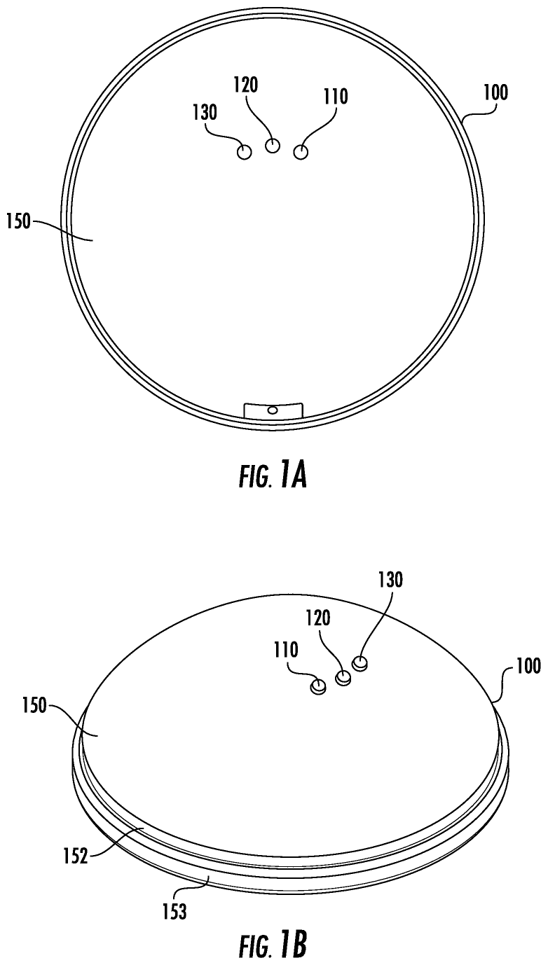

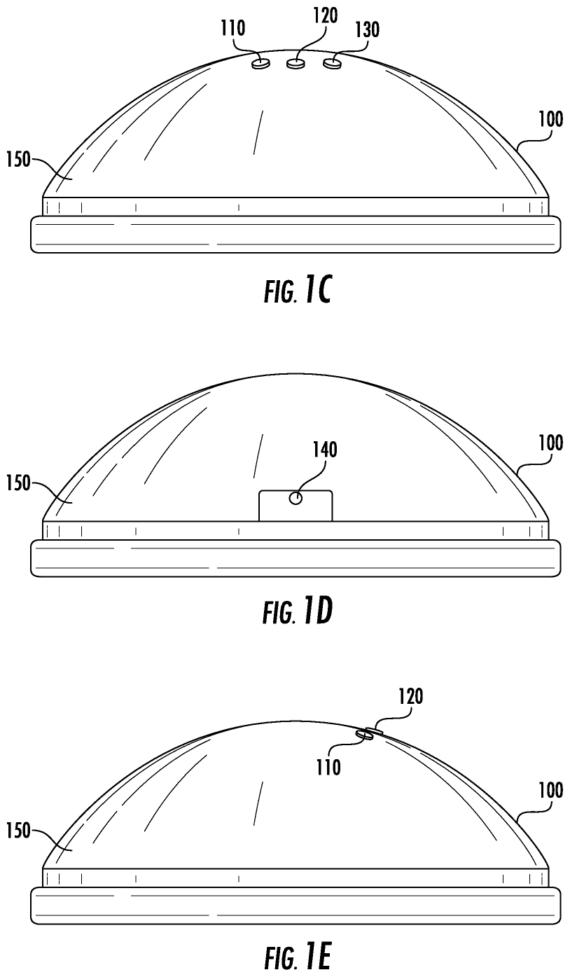

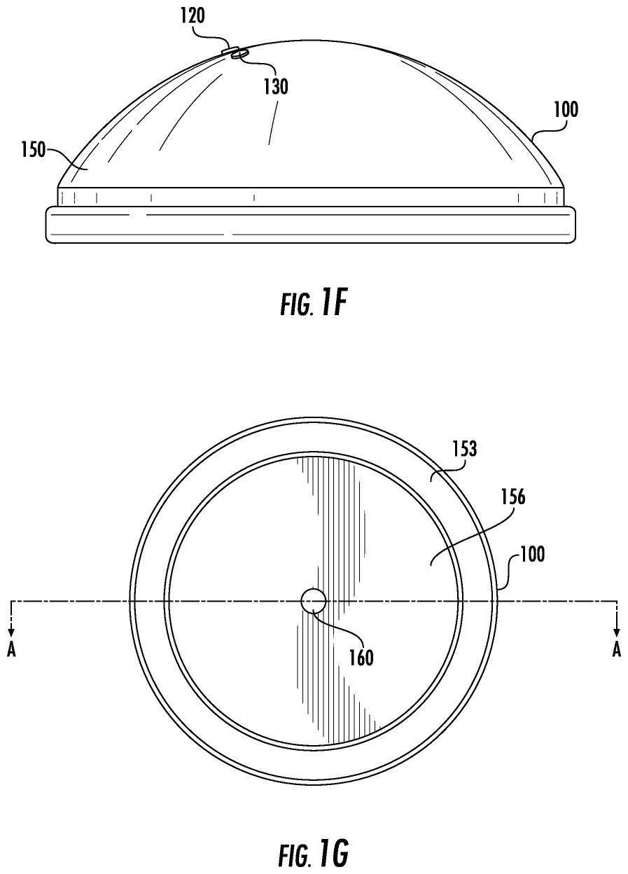

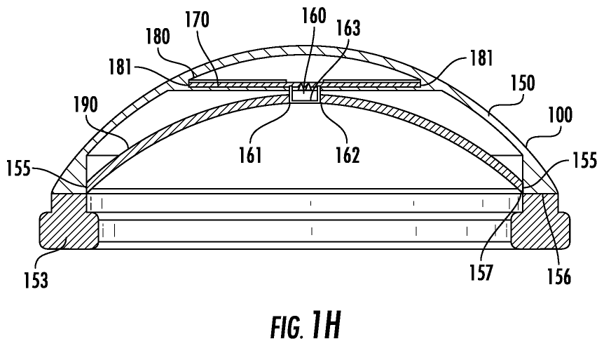

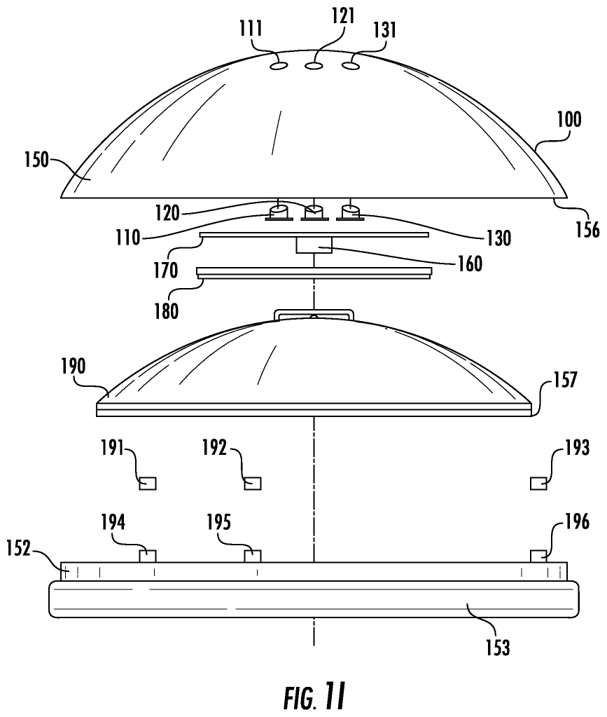

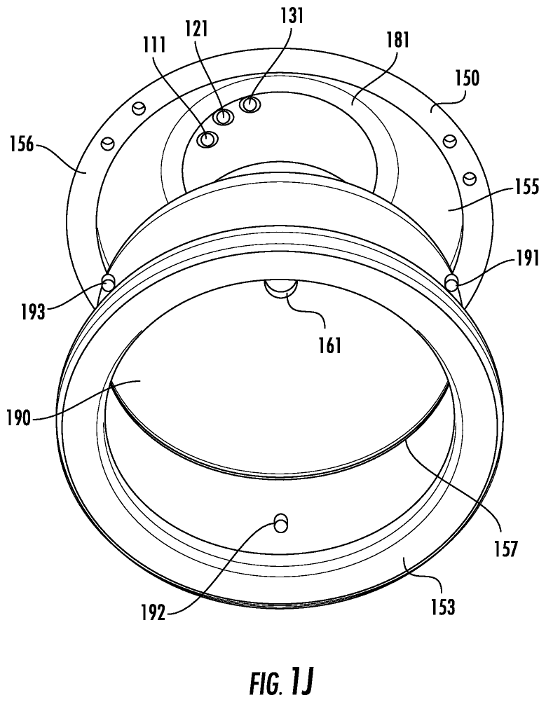

Referring to FIGS. 1A to 1J, an embodiment of a microphone assembly is illustrated. The microphone assembly 100 comprises an outer shell 150 having an opening 156 and a rim 157 around the opening 156. A microphone 160 is fixed within the outer shell 150, and a flexible membrane 153 is fixed to the rim of the outer shell. The flexible membrane 153 may cover the entire rim while leaving the opening 156.

The flexible membrane 153 may be foam. The outer shell may comprising a foam ring 153 by which the foam is attached to the microphone assembly. The flexible membrane may be brought into contact with the wall of an instrument in a system herein. The microphone assembly 100 may then be adhered to the instrument. The adherence may be provided by a strap over the assembly 100, by gravity if the wall of the instrument is generally below the assembly 100, or any other physical arrangement to keep the flexible membrane in contact with the instrument.

The microphone assembly of claim may further comprise an inner shell 190 within the outer shell 150. A device communicatively connecting the microphone 160 to external devices may be present. The device communicatively connecting the microphone 160 may be a printed circuit board 170, which may be supported by a printed circuit board support ring 180. The microphone assembly may comprise a microphone slot 161 within the inner shell 190. The microphone 160 may include a first portion 162 within the slot 161 and a second portion 163 associated with the printed circuit board 170. The microphone assembly may comprising a printed circuit board support ring receiver 181 in the outer shell 150 on which the printed circuit board support ring 180 is received. The inner shell 190 may be connected to the outer shell 150 at a region of an inner wall 155 of the outer shell 150.

The microphone assembly 100 may comprise a volume down button 110, and a volume down button hole in the outer shell 150 through which the volume down button protrudes. The volume down button may be operatively connected to the microphone. Likewise, the microphone assembly may comprise a power button 120 and a volume up button 130, and the outer shell 150 may comprises a hole 121 and hole 131 through which the power button 120 and the volume up button 130 protrude, respectively.

The microphone assembly may comprise a cable port/cable strain relief 140. The microphone assembly may also comprise magnets 191, 192, 193, and alignment pins 194, 195, and 196 that may be spaced around the assembly for support. The pins may be slightly offset and also spaced to align the ring to the outer shell. The spacing may be even spacing. The spacing may be around the axis of the assembly.

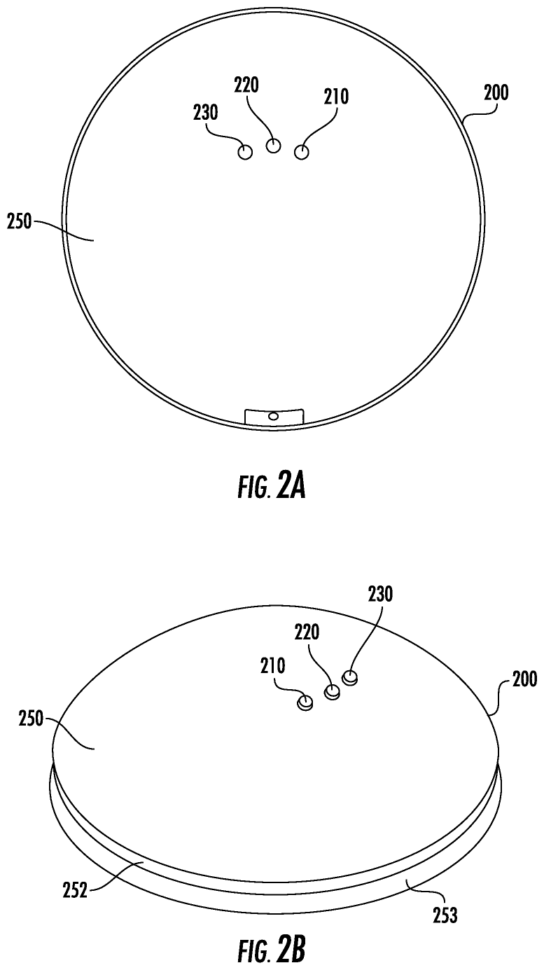

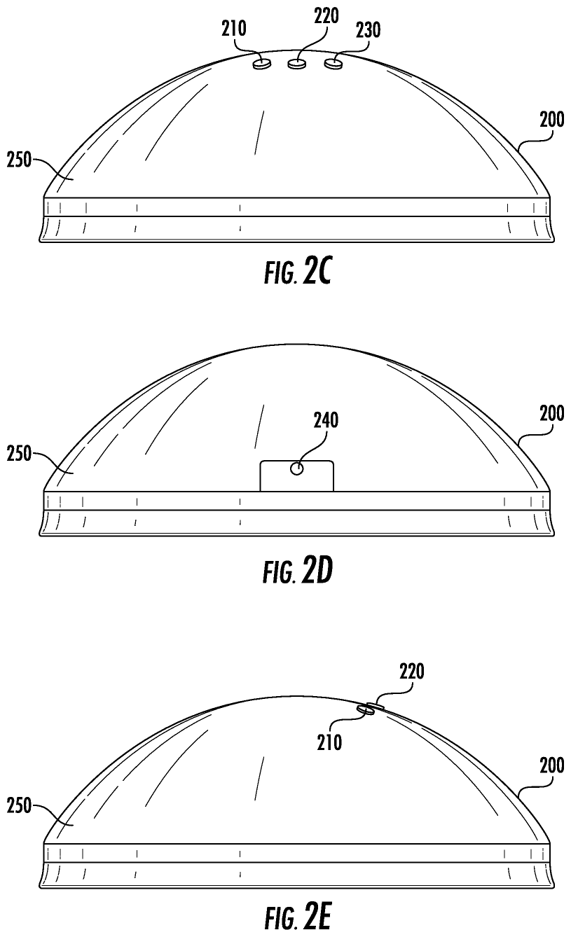

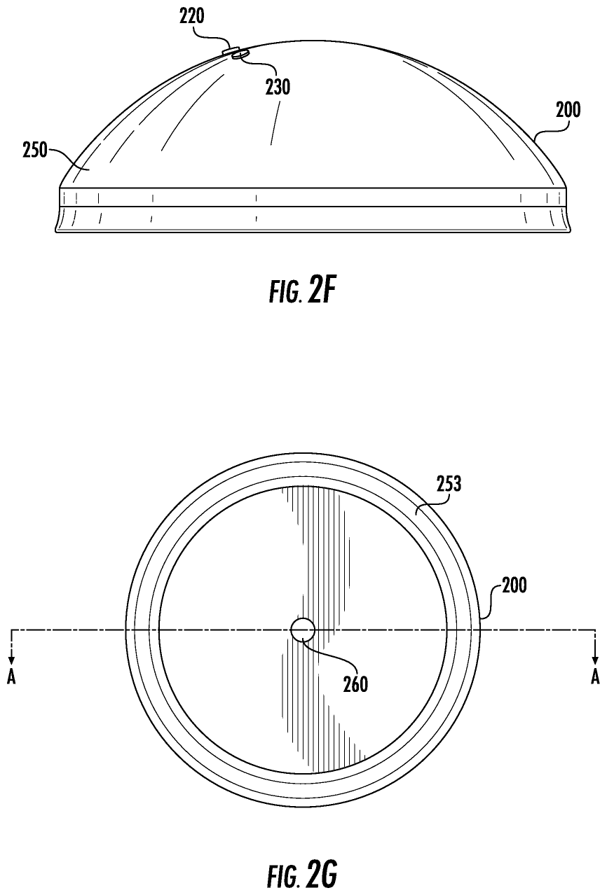

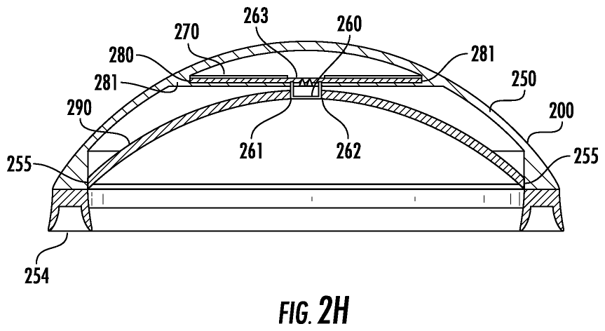

Referring to FIGS. 2A to 2H, an embodiment of a microphone assembly is illustrated. Features in FIGS. 2A to 2H similar to those in FIGS. 1A to 1H are marked with reference characters one hundred greater than those in FIGS. 1A to 1H. An exception to this pattern is at elements 252 and 254, which are a vacuum seal support ring 252 and a vacuum seal 253 in FIGS. 2A to 2H. FIG. 2H also illustrates a vacuum chamber 254 where FIG. 1H illustrated part of foam 153. The vacuum seal may contact the wall of an instrument in a system herein. Vacuum may be created in the vacuum chamber 254 to adhere the assembly 200 to the instrument.

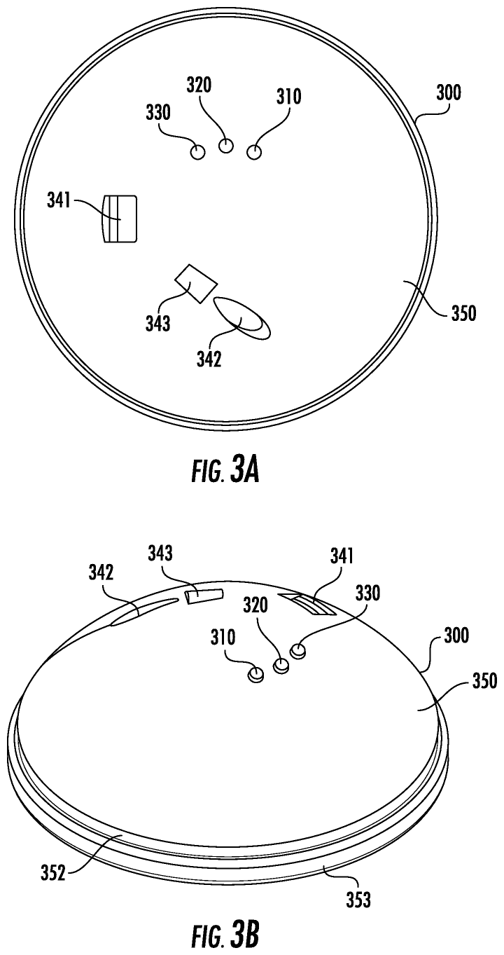

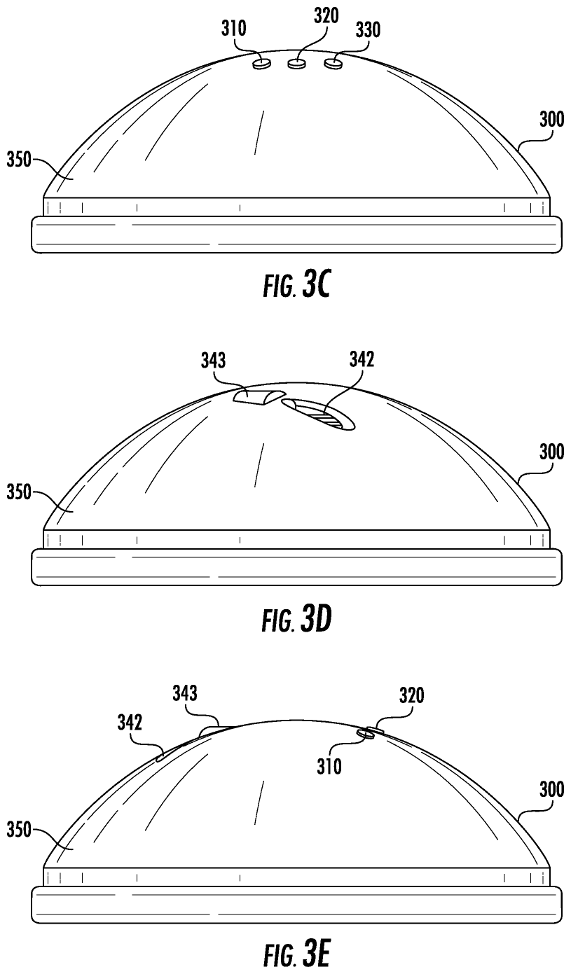

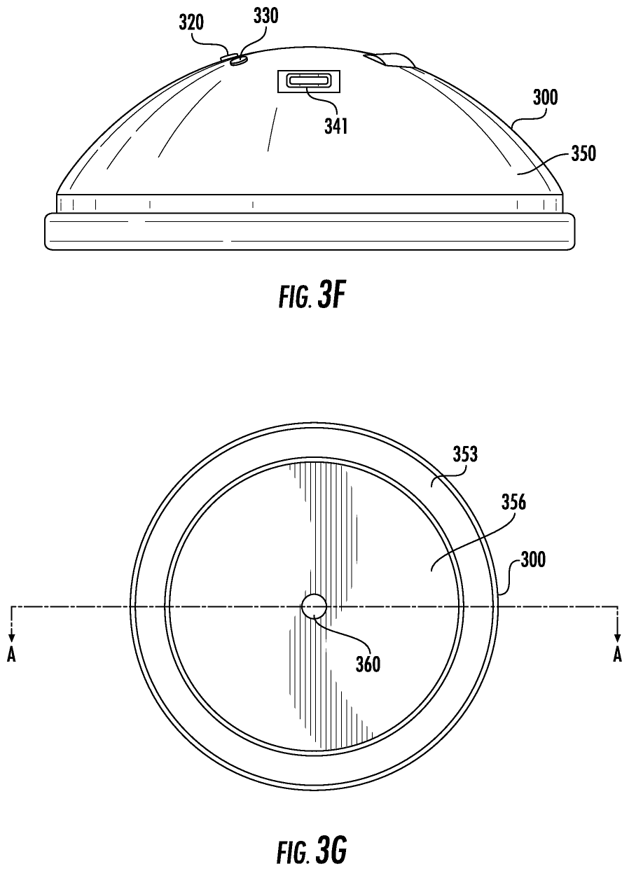

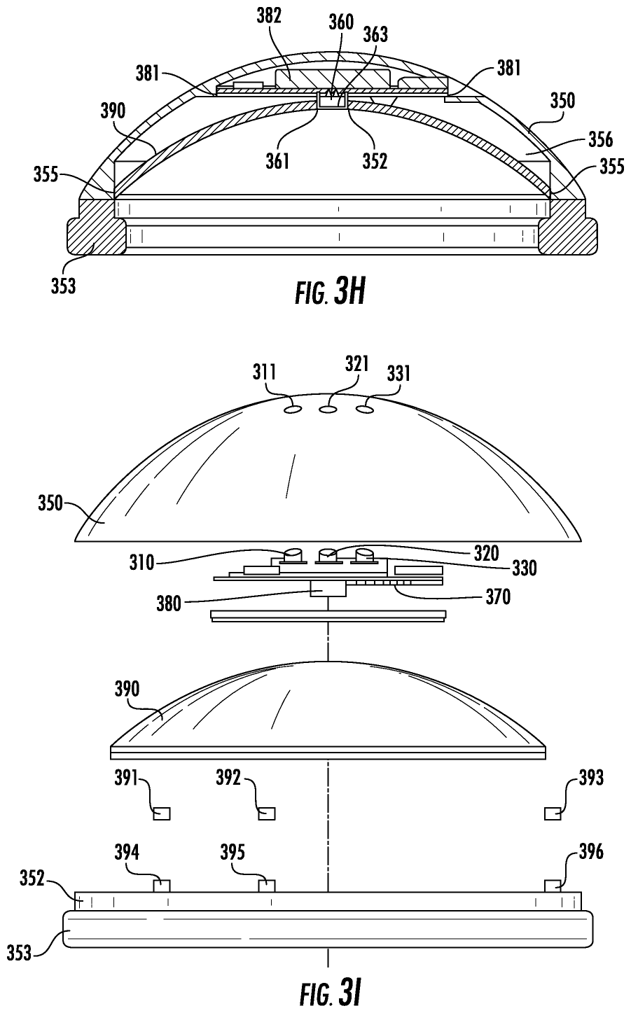

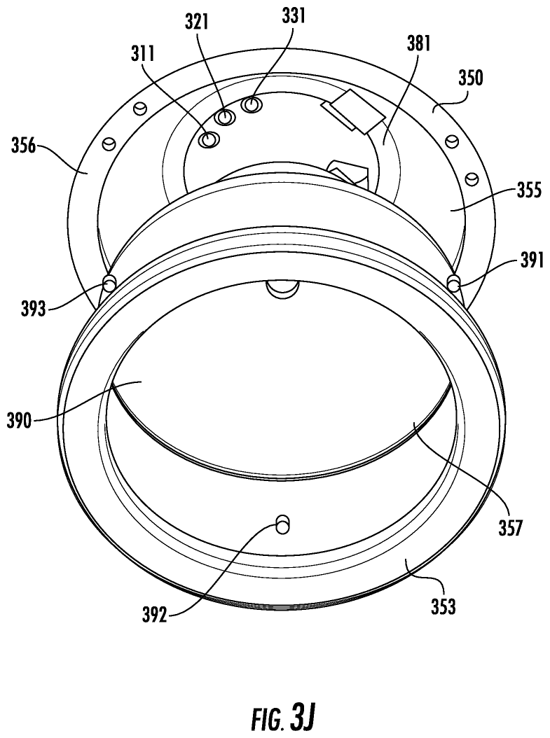

Referring to FIGS. 3A to 3J, an embodiment of a microphone assembly is illustrated. Features in FIGS. 3A to 3J similar to those in FIGS. 1A to 1J are marked with reference characters two hundred greater than those in FIGS. 1A to 1J. FIGS. 3A to 3J add a USB port 341 and audio port 342. A protrusion 343 is illustrated in FIG. 3A. The protrusion 343 in the embodiment illustrated allows for the audio port to fit within the space provided. But a protrusion may not be necessary for other positions for the audio port, or different configurations of the microphone assembly. not necessary to the design otherwise. The audio port 342 may be a 1/8 inch port. FIG. 3H also illustrates a battery 382. The battery 382 may be a surface mount lithium battery.

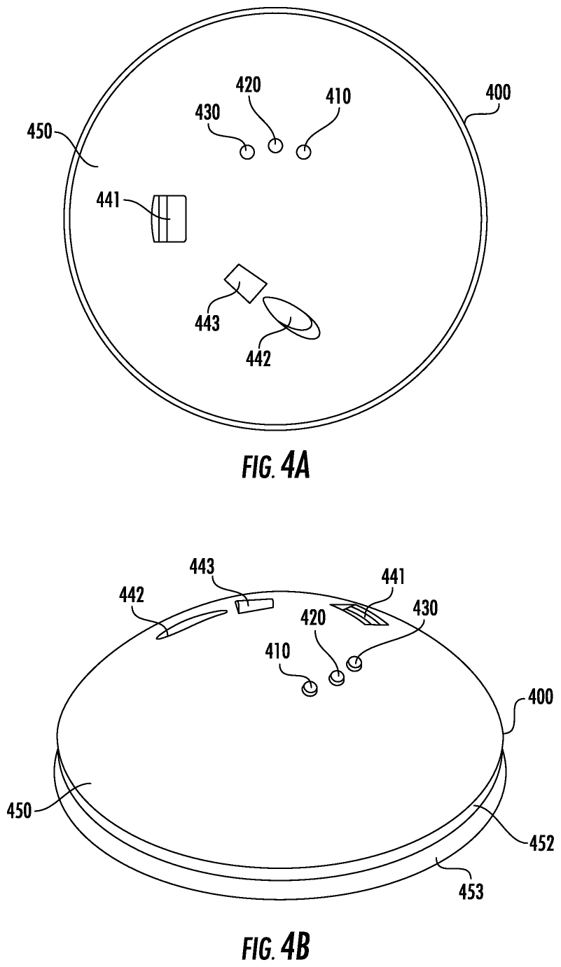

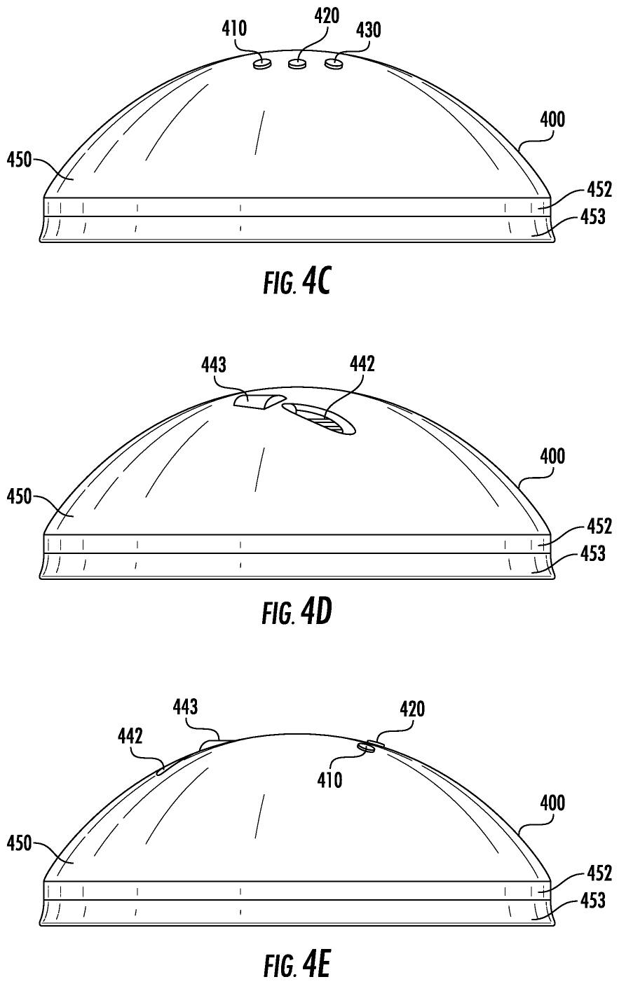

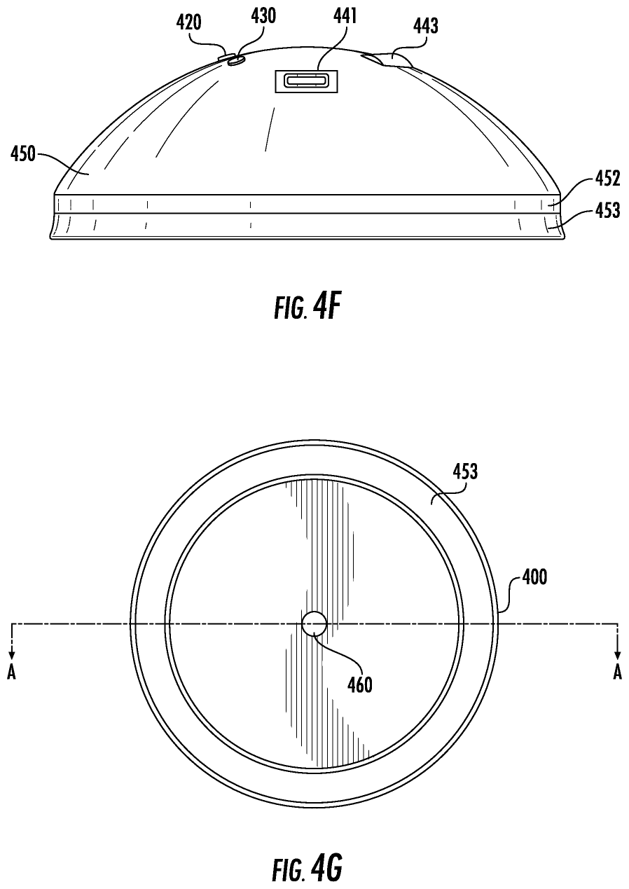

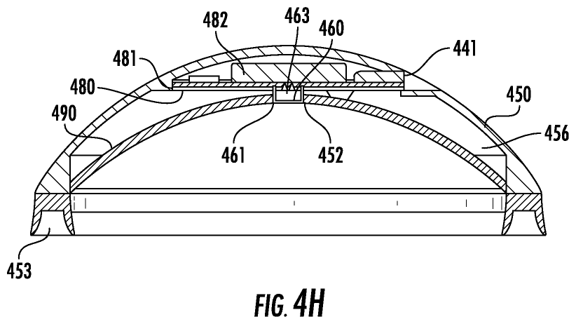

Referring to FIGS. 4A to 4H, an embodiment of a microphone assembly is illustrated. Features in FIGS. 4A to 4H similar to those in FIGS. 1A to 1H are marked with reference characters three hundred greater than those in FIGS. 1A to 1H. An exception to this pattern is at elements 452 and 454, which are a vacuum seal support ring 452 and a vacuum seal 453 in FIGS. 4A to 4H. FIG. 4H also illustrates a vacuum chamber 454 where FIG. 1H illustrated part of foam 153. The vacuum seal may contact the wall of an instrument in a system herein. Vacuum may be created in the vacuum chamber 454 to adhere the assembly 400 to the instrument. FIGS. 4A to 4H add a USB port 441 and audio port 442. The audio port 442 may be but is not limited to a 1/8 or 1/4 inch port. FIG. 4H also illustrates a battery 482. The battery 482 may be a surface mount lithium battery.

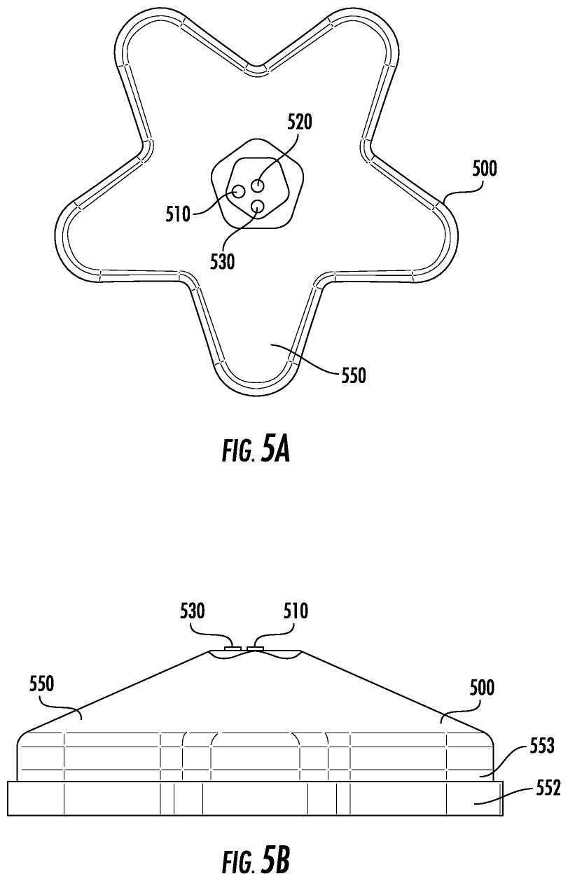

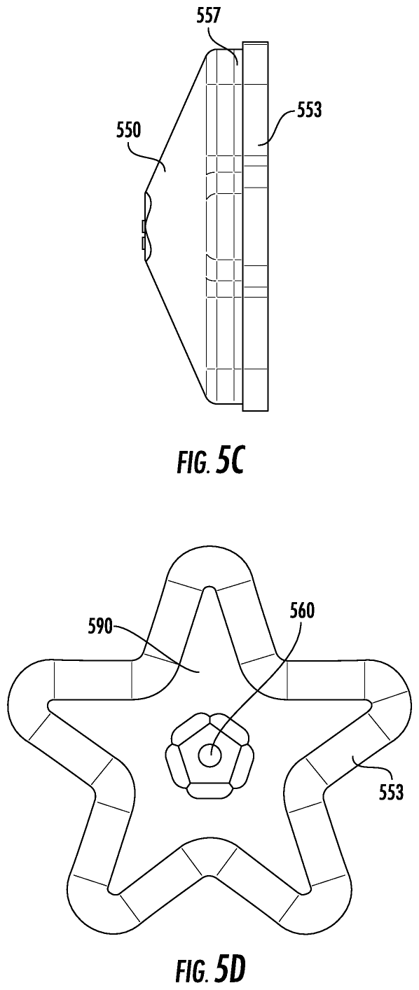

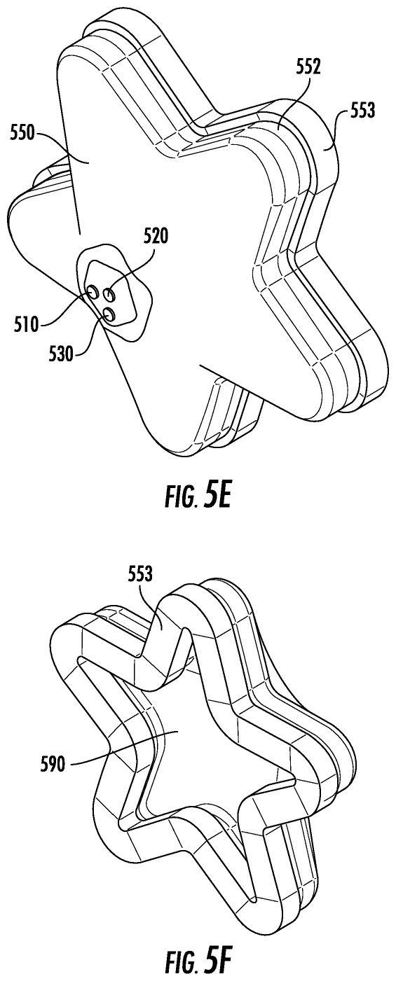

Referring to FIGS. 5A to 5F, an embodiment of a microphone assembly is illustrated. Features in FIGS. 5A to 5F similar to those in FIGS. 1A to 1H are marked with reference characters four hundred greater than those in FIGS. 1A to 1H. FIGS. 5A to 5F illustrate an embodiment where a microphone assembly 400 takes a different general shape than those illustrated in prior figures. The shape illustrated in FIGS. 5A to 5F is star shaped. Embodiments include other shapes. The other shapes may be adopted for utility or aesthetic reasons. The utility reasons may include a shape that will fit a particular region of an instrument.

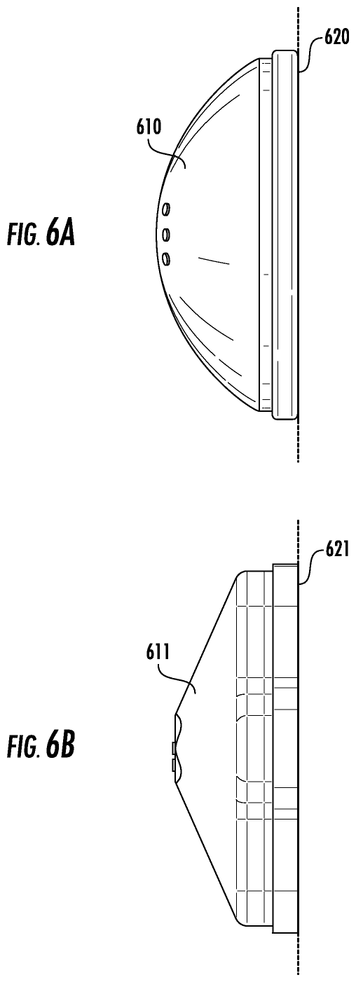

FIGS. 6A and 6B illustrate microphone assemblies in contact with the surface of respective instruments. In FIG. 6A, the microphone assembly 610 is in contact with the wall 620 of instrument. In FIG. 6B, the microphone assembly 611 is in contact with the wall 621 of instrument.

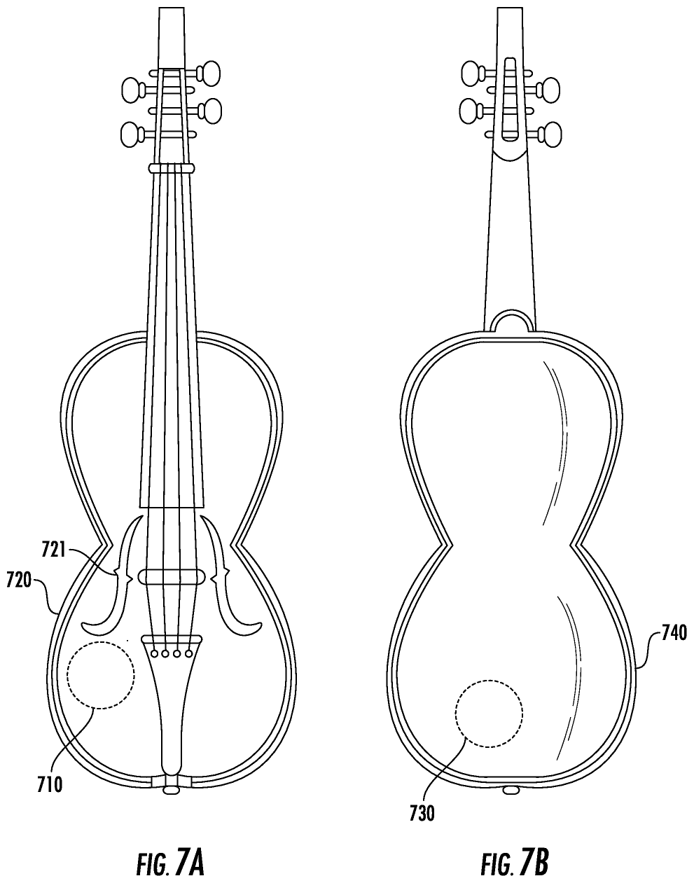

Referring to FIGS. 7A and 7B, non-limiting exemplary positions of a microphone assembly on a violin are illustrated. FIG. 7A illustrates an embodiment where a microphone assembly is at position 710 on the front of a violin 720 between the chin rest (not illustrated) and sound hole 721. In this embodiment in FIG. 7A, the microphone assembly is not overlapping the sound hole 721 of the violin. FIG. 7B illustrates an embodiment with a position 730 for the microphone assembly on the back of a violin 740, between under the shoulder rest (not illustrated) and the back of the violin 740.

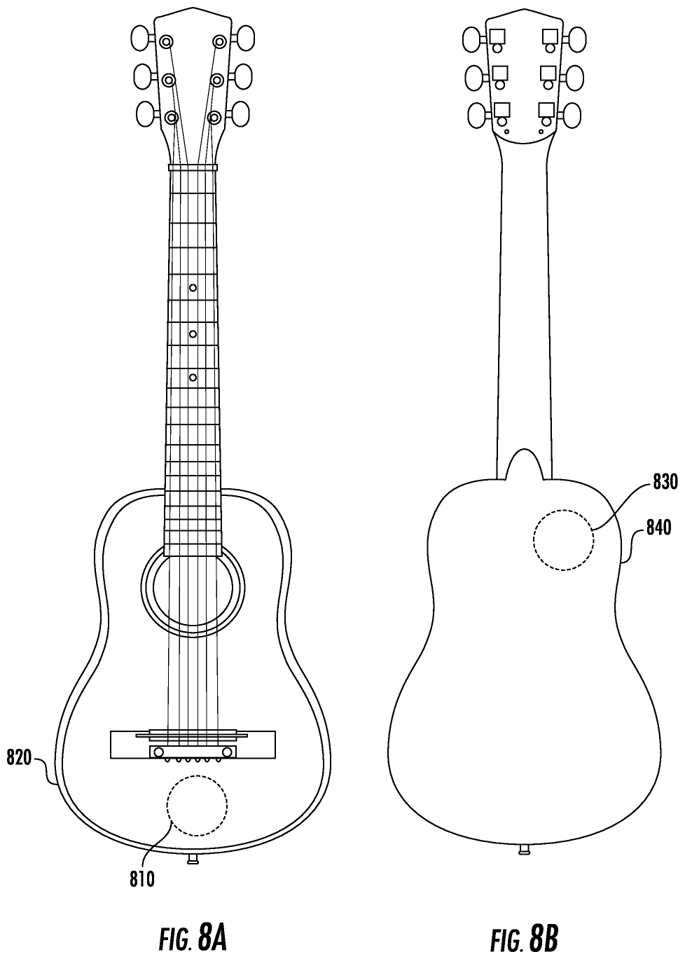

Referring to FIGS. 8A and 8B, potential positions of the microphone assembly on a guitar are illustrated. FIG. 8A illustrates an embodiment with a position 810 for a microphone assembly on the front of a guitar 820. FIG. 8B illustrates an embodiment with a position 830 for a microphone assembly on the back of a guitar 840.

The skilled artisan will understand the materials a microphone assembly may be made of. Non-limiting options include the following. The shells, one of or both internal and external, may be made from plastics. The plastic may be an ABS plastic. The foam ring may be a neoprene or EPDM foam, with or without an outer coating. The vacuum seal may be a neoprene, EPDM, or silicone rubber. A circuit board provided in any embodiment may be a standard board. The assembly of the device may include fasteners, which may be screws. The assembly of the device may include no screws at all and instead have snaps built into the plastic to assemble everything, or there may be snaps as well as screws attach various parts within the assembly. Any other fastener arrangement by be implemented.

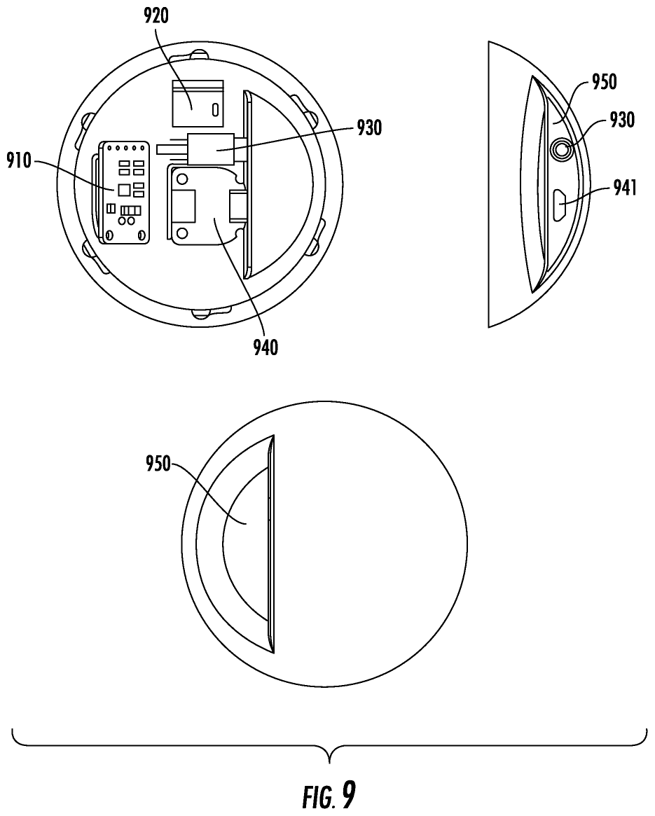

FIG. 9 illustrates an embodiment of a microphone assembly including an audio amplifier board 910, a lithium battery 920, a 3.5 mm audio port 930, a USB port and management board 940. The USB port on the exterior of the embodiment is separately labeled as the USB port 941. The electronics have been separated into multiple components. This allows for flexibility during of design. Fewer boards or even a single board may, however, include all of the electronics. The skilled artisan will understand that a variety of audio ports, drive ports, batteries may be present in place or in addition to those illustrated in this or any other embodiment herein. An embodiment herein may include any form of input, output, or input/output port. Also illustrated is a notch 950, which provides space for access to the audio port 930 and the USB port 941. The notch 950 is merely one configuration to provide space for access. A variety of other shapes or configurations for a space for access could be adopted for either utility or aesthetic reasons.

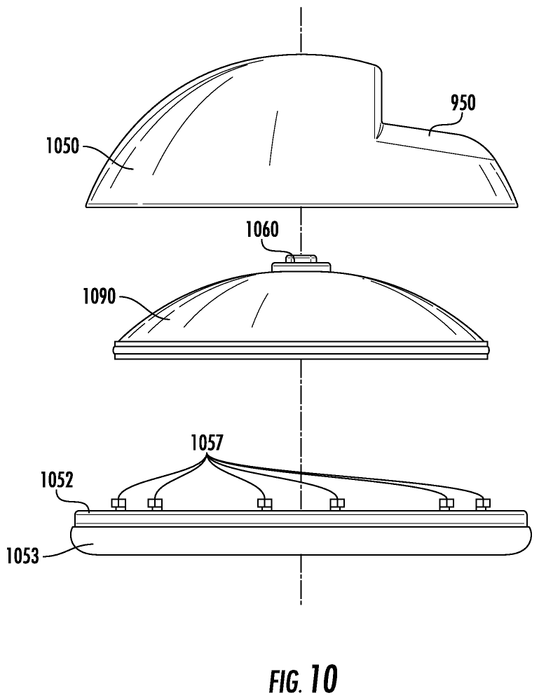

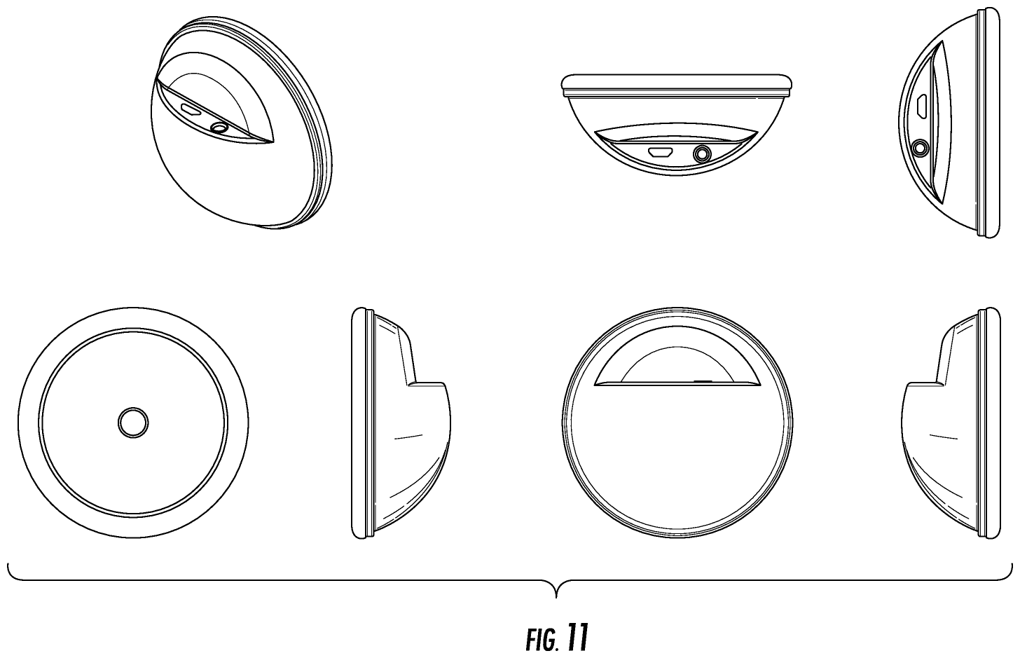

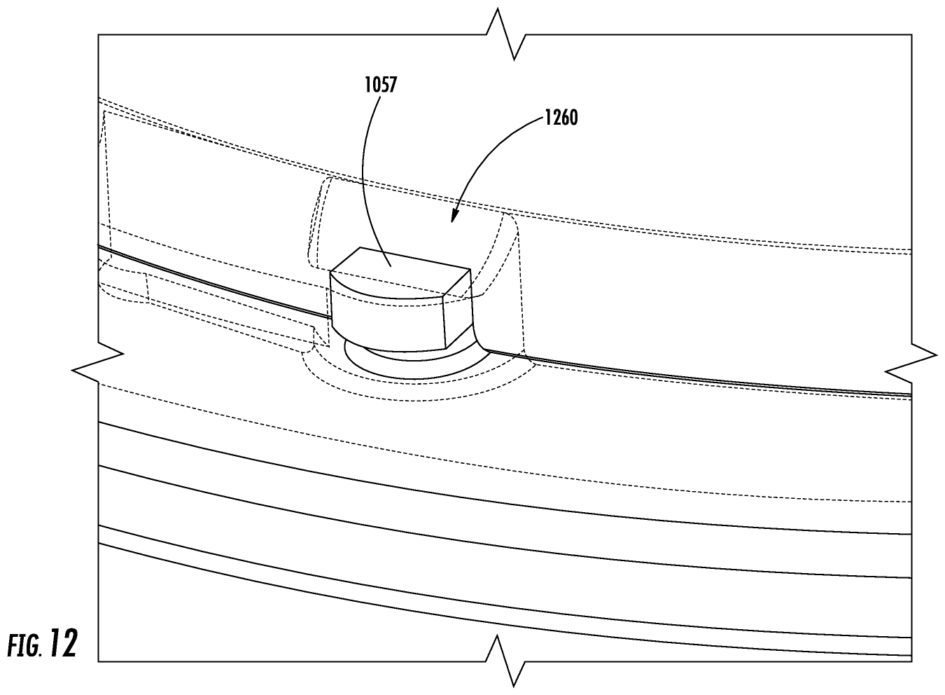

Referring to FIG. 10, an exploded view of the embodiment of FIG. 9 is illustrated. The embodiment includes the notch 950 an outer shell 1060, an inner shell 1090, a microphone 1060, a foam support ring 1052, and a foam ring 1053. The embodiment also includes foam ring retention clips 1057. These are a twist lock type connection, rather than magnetic. This does not necessarily rule out the inclusion of a magnetic attachment in this or other embodiments herein. The twist lock involves inserting the clips into receiving areas in the outer shell and turning the ring until to an installed position. The installed position may include a locking structure to secure the foam ring in place. The locking structure may click as it is engaged to signify it is engaged.

FIG. 11 includes various views of the embodiment of FIG. 9.

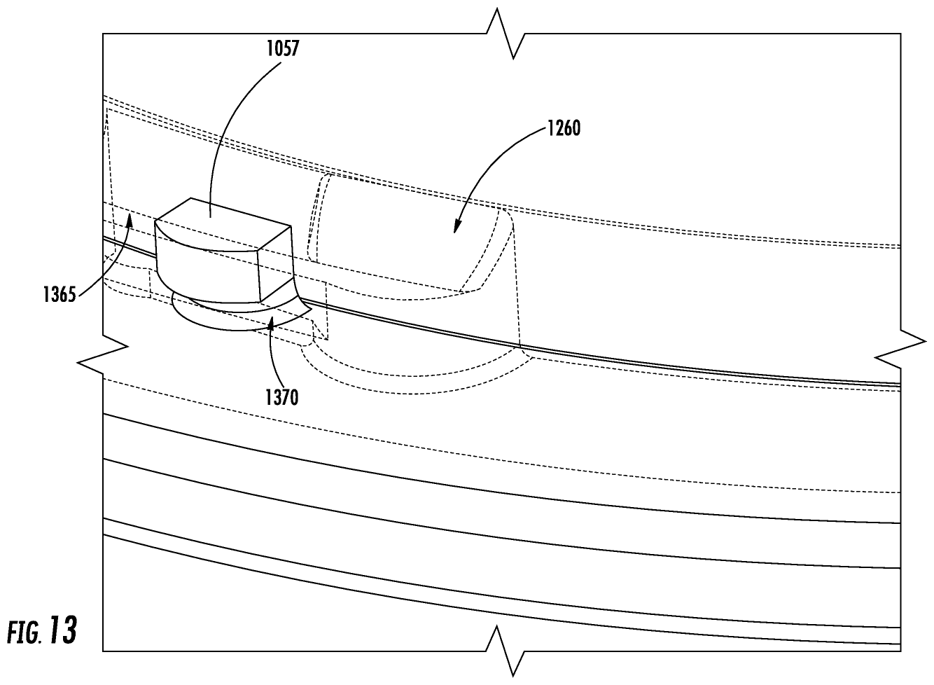

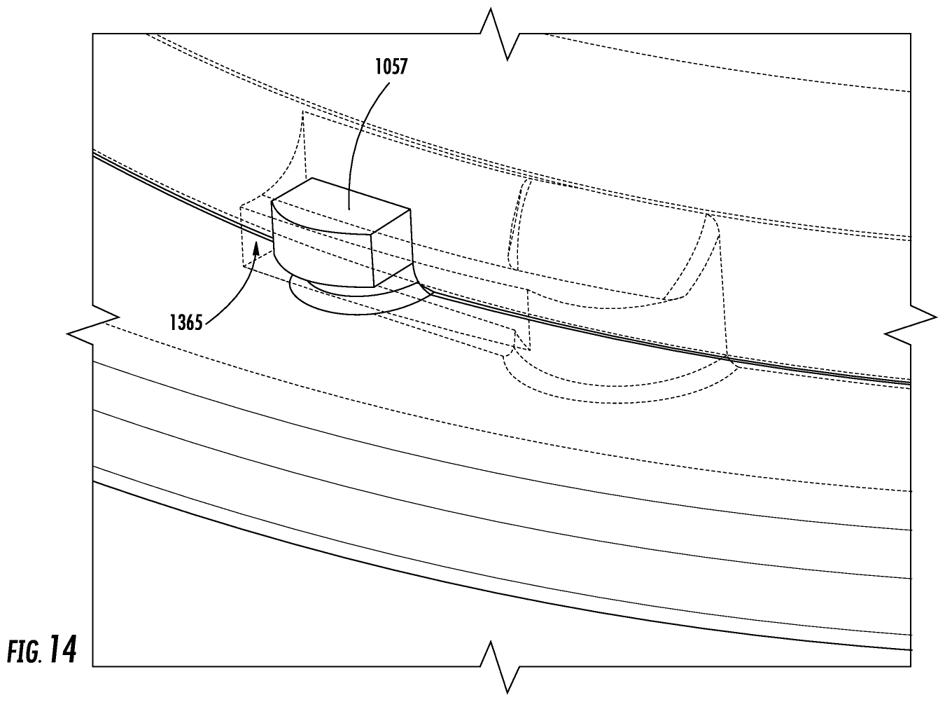

FIG. 12 illustrates the embodiment of FIG. 9 with a foam ring retention clip 1057 engaging a receiving area 1260. FIG. 13 illustrates the same embodiment, where retention clip 1057 has moved along shelf 1370 within the receiving area 1260 toward the back 1365 of the receiving area. FIG. 14 illustrates the retention clip 1057 at the back 1365 of the receiving area 1260. In combination, FIGS. 12, 13, and 14 illustrate the twist lock connection.

Embodiment List.

The following list enumerates particular embodiments. It does not, however, limit the embodiments of this application to only those listed below.

1. A microphone assembly comprising:

an outer shell having an opening and a rim around the opening, a microphone fixed within the outer shell, and a flexible membrane on the rim of the outer shell.

2. The microphone assembly of embodiment 1 further comprising an inner shell within the outer shell, a printed circuit board, a printed circuit board support ring, a microphone slot within the inner shell, and a printed circuit board support ring receiver, wherein the inner shell is connected to the outer shell at a region of an inner wall of the outer shell, the microphone includes a first portion within the microphone slot and a second portion associated with the printed circuit board, the printed circuit board is supported by the printed circuit board ring, and the printed circuit board ring is supported by the printed circuit board support ring receiver.

3. The microphone assembly of embodiment 2, wherein the region of the inner wall of the outer shell is proximal to the rim.

4. The microphone assembly of any of the preceding embodiments, wherein the flexible membrane is foam.

5. The microphone assembly of any of the preceding embodiments, wherein the flexible membrane is a vacuum seal.

6. The microphone assembly of embodiment 5, wherein the vacuum seal is rubber.

7. The microphone assembly of any of embodiments 2 to 6, wherein the outer shell and the inner shell are semi-spherical.

8. The microphone assembly of any of embodiments 2 to 6, wherein the outer shell and the inner shell are star shaped.

9. The microphone of assembly embodiment 1, wherein the outer shell is semi-spherical.

10. The microphone of assembly embodiment 1, wherein the outer shell is star shaped.

11. The microphone assembly of any of embodiments 1 to 10, wherein the rim is planar.

12. The microphone assembly of any of embodiments 1 to 11, wherein the flexible membrane is planar.

13. The microphone assembly of any of embodiments 1 to 10, wherein the rim is adapted to conform to the contours of an instrument.

14. The microphone assembly of any of embodiments 1 to 10 and 13, wherein the flexible membrane is adapted to conform to the contours of an instrument.

15. The microphone assembly of any one of embodiments 1 to 12 further comprising a power source operably connected to the microphone.

16. The microphone assembly of embodiment 15, wherein the power source is a battery.

17. The microphone assembly of embodiment 16, wherein the battery is within the outer shell.

18. The microphone assembly of embodiment 16, wherein the battery is rechargeable.

19. The microphone assembly of any one of embodiments 1 to 18 further comprising an audio out port communicatively coupled to the microphone.

20. The microphone assembly of any one of embodiments 1 to 19 further comprising a USB port communicatively coupled to the microphone.

21. The microphone assembly of any one of embodiments 1 to 20 further comprising at least one of a power on/off control, volume up/down control, volume up control, or volume down control operatively connected to the microphone.

22. The microphone assembly of any one of embodiments 1 to 21 further comprising a control panel communicatively coupled to the microphone.

23. The microphone assembly of embodiment 22, wherein the control panel is on or within the outer shell.

24. The microphone assembly of embodiment 22, wherein the control panel is external to the outer shell, optionally not connected to the outer shell, and remotely coupled to the microphone.

25. A system comprising at least one microphone assembly of any of embodiments 1 to 24, an instrument, and an output device, wherein the one of the at least one microphone assembly is attached to a wall of the instrument.

26. The system of embodiment 25 further comprising one or more further devices communicatively coupled to the microphone.

27. The system of embodiment 26, wherein the one or more further devices comprise at least one of an amplifier, a mixing board, a cell phone, a laptop computer, a computer, and a speaker.

28. A method of obtaining an audio output from an instrument comprising coupling the instrument with the microphone assembly of any one of embodiments 1 to 24 or an assembly comprising the microphone assembly of any one of embodiments 1 to 24 and one or more further devices.

27. The method of embodiment 28, wherein the one or more further devices comprise at least one of an amplifier, a mixing board, a cell phone, a laptop computer, a computer, and a speaker.

### REFERENCE CHARACTER LIST

100 Microphone assembly
110 Volume down button
111 Volume down button hole
120 Power button
121 Power button hole
130 Volume up button
131 Volume up button hole
140 Cable port/cable strain relief
150 Outer shell
152 Foam support ring
153 Foam ring (flexible membrane)
155 Region of inner wall of outer shell
156 Outer shell opening
160 Microphone
161 Microphone slot
162 First portion of microphone within the slot
163 Second portion of microphone associated with the printed circuit board
170 PCB (printed circuit board)
180 PCB support ring
181 Printed circuit board support ring receiver
190 Inner shell
191 Magnet
192 Magnet
193 Magnet
194 Alignment pin
195 Alignment pin
196 Alignment pin
200 Microphone assembly
210 Volume down button
211 Volume down button hole
220 Power button
221 Power button hole
230 Volume up button
231 Volume up button hole
240 Cable port/cable strain relief
250 Outer shell
252 Vacuum seal support ring
253 Vacuum seal (flexible membrane, may be rubber)
254 Vacuum chamber
255 Region of inner wall of outer shell
260 Microphone
261 Microphone slot
262 First portion of microphone within the slot
263 Second portion of microphone associated with the printed circuit board
270 PCB
280 PCB support ring
281 Printed circuit board support ring receiver
290 Inner shell
300 Microphone assembly
310 Volume down button
311 Volume down button hole
320 Power button
321 Power button hole
330 Volume up button
331 Volume up button hole
341 USB port
342 Audio port
343 Protrusion
350 Outer shell
352 Foam support ring
353 Foam ring (flexible membrane)
355 Region of inner wall of outer shell
360 Microphone
361 Microphone slot
362 First portion of microphone within the slot
363 Second portion of microphone associated with the printed circuit board
370 PCB
380 PCB support ring
381 Printed circuit board support ring receiver
382 Battery
390 Inner shell
391 Magnet
392 Magnet
393 Magnet
394 Alignment pin
395 Alignment pin
396 Alignment pin
400 Microphone assembly
410 Volume down button
411 Volume down button hole
420 Power button
421 Power button hole
430 Volume up button
431 Volume up button hole
441 USB port
442 Audio port
443 Protrusion
450 Outer shell
452 Vacuum seal support ring
453 Vacuum seal (flexible membrane, may be rubber)
454 Vacuum chamber
455 Region of inner wall of outer shell
460 Microphone
461 Microphone slot
462 First portion of microphone within the slot
463 Second portion of microphone associated with the printed circuit board
470 PCB
480 PCB support ring
481 Printed circuit board support ring receiver
482 Battery
490 Inner shell
500 Microphone assembly
510 Volume down button
520 Power button
530 Volume up button
550 Outer shell
552 Foam support ring
553 Foam ring
560 Microphone
590 Inner shell
610 Microphone assembly
611 Microphone assembly
620 Wall of an instrument
621 Wall of an instrument
710 Position of microphone assembly
720 Wall of a violin
721 Sound hole of a violin
730 Position of microphone assembly
740 Wall of a violin
810 Position of microphone assembly
820 Wall of a guitar
830 Position of microphone assembly
840 Wall of a guitar
910 Audio amplifier board
920 Lithium battery
930 3.5 mm audio port
940 USB port and management board
941 USB port
950 Notch
1060 Outer shell
1090 Inner shell
1060 Microphone
1052 Foam support ring
1053 Foam ring
1057 Foam retention clips
1260 Receiving area
1370 Shelf
1365 Back of receiving area

Further embodiments include those formed by starting with any one embodiment herein and adding one or more element from one or more other embodiment herein. Still further embodiments include those formed by starting with any one embodiment herein and substituting one or more element therein with one or more element from another embodiment herein. Still further embodiments include those formed by starting with any one embodiment herein and both adding or substituting one or more elements therein with one or more elements from one or more other embodiments herein.

It is understood, therefore, that this invention is not limited to the particular embodiments disclosed, but is intended to cover all modifications which are within the spirit and scope of the invention as defined by the appended claims, the above description, and/or shown in the attached drawings.

1. A microphone assembly comprising:
an outer shell having an opening and a rim around the opening, a microphone fixed within the outer shell, and a flexible membrane on the rim of the outer shell, the microphone assembly further comprising
an inner shell within the outer shell, a printed circuit board, a printed circuit board support ring, a microphone slot within the inner shell, and a printed circuit board support ring receiver, wherein the inner shell is connected to the outer shell at a region of an inner wall of the outer shell, the microphone includes a first portion within the microphone slot and a second portion associated with the printed circuit board, the printed circuit board is supported by the printed circuit board ring, and the printed circuit board ring is supported by the printed circuit board support ring receiver.

2. (canceled)

3. The microphone assembly of claim 1, wherein the region of the inner wall of the outer shell is proximal to the rim.

4. The microphone assembly of claim 1, wherein the flexible membrane is foam.

5. The microphone assembly of claim 1, wherein the flexible membrane is a vacuum seal.

6. The microphone assembly of claim 5, wherein the vacuum seal is rubber.

7. The microphone assembly of claim 1, wherein the outer shell and the inner shell are semi-spherical.

8. The microphone assembly of claim 1, wherein the outer shell and the inner shell are star shaped.

9.-12. (canceled)

13. The microphone assembly of claim 1, wherein the rim is adapted to conform to the contours of an instrument.

14. The microphone assembly of claim 1, wherein the flexible membrane is adapted to conform to the contours of an instrument.

15. The microphone assembly of claim 1 further comprising a power source operably connected to the microphone.

16. (canceled)

17. The microphone assembly of claim 15, wherein the power source is a battery.

18. The microphone assembly of claim 17, wherein the battery is rechargeable.

19. The microphone assembly of claim 1 further comprising an audio out port communicatively coupled to the microphone.

20. The microphone assembly of claim 1 further comprising a USB port communicatively coupled to the microphone.

21. The microphone assembly of claim 1 further comprising at least one of a power on/off control, volume up/down control, volume up control, or volume down control operatively connected to the microphone.

22. The microphone assembly of claim 1 further comprising a control panel communicatively coupled to the microphone.

23. The microphone assembly of claim 22, wherein the control panel is on or within the outer shell.

24. The microphone assembly of claim 22, wherein the control panel is external to the outer shell, optionally not connected to the outer shell, and remotely coupled to the microphone.

25. A system comprising at least one microphone assembly of claim 1, an instrument, and an output device, wherein the one of the at least one microphone assembly is attached to a wall of the instrument,
the system optionally further comprising a control panel communicatively coupled to the microphone, wherein the control panel is optionally on or within the outer shell, external to the outer shell, or not connected to the outer shell and remotely coupled to the microphone.

26. The system of claim 25 further comprising one or more further devices communicatively coupled to the microphone, optionally wherein the one or more further devices comprise at least one of an amplifier, a mixing board, a cell phone, a laptop computer, a computer, and a speaker.

27.-29. (canceled)
